(19) United States
(12) Patent Application Publication
(10) Pub. No.: US 2026/0122314 A1
(43) Pub. Date: Apr. 30, 2026

(54) VIDEO INTERSTITIAL EXPERIENCE OPTIMIZED FOR OVER THE TOP HOMESCREEN USER EXPERIENCE

(71) Applicant: Roku, Inc., San Jose, CA (US)

(72) Inventors: Mehul Sanghavi, San Jose, CA (US); Shashank Merchant, Sunnyvale, CA (US); David Webb, Milpitas, CA (US); Phi Thuan Au, Austin, TX (US); Yoshihiro Mizutani, Santa Clara, CA (US); Oleg Iakovlev, Acton, MA (US); Robert Lynn Marquardt, Pacifica, CA (US); Amit Kumar Sharma, Mountain House, CA (US)

(21) Appl. No.: 19/374,802

(22) Filed: Oct. 30, 2025

Related U.S. Application Data
(60) Provisional application No. 63/714,811, filed on Oct. 31, 2024.

(51) Int. Cl. H04N 21/443; H04N 21/231; H04N 21/472

(52) U.S. Cl. CPC H04N 21/4438; H04N 21/23106; H04N 21/47217

(57) ABSTRACT

System, apparatus, article of manufacture, method and/or computer program embodiments are provided for delivering a secondary content item based on a user return event. An example method may include detecting a user return event; pre-fetching and pre-buffering a secondary content item during an idle period preceding the user return event; and initiating a transition effect based on the user return event, the transition effect includes partially displacing a home screen interface and displaying the secondary content item in a defined region of a screen.

### CROSS-REFERENCE TO RELATED APPLICATIONS

This application claims the benefit of, and priority to, U.S. Provisional Application No. 63/714,811 filed on Oct. 31, 2024, the contents of which are incorporated herein by reference in their entirety and for all purposes.

### BACKGROUND

### Field

The disclosed invention provides solutions for delivering secondary content or secondary content item(s) on a media device, such as a smart TV platform. In particular, the disclosed technology includes solutions for providing a novel interstitial secondary content (e.g., advertisements) format for OTT (over-the-top) media home screen interfaces.

### SUMMARY

Provided herein are system, apparatus, article of manufacture, method and/or computer program product embodiments, and/or combinations and sub-combinations thereof, for delivering a secondary content item based on a detected user return event. In some aspects, a computer-implemented method is disclosed for delivering a secondary content item based on a detected user return event. The computer-implemented method may include detecting a user return event; pre-fetching and pre-buffering a secondary content item during an idle period preceding the user return event; and initiating a transition effect based on the user return event, the transition effect includes partially displacing a home screen interface and displaying the secondary content item in a defined region of a screen.

In some examples, a system is provided for delivering a secondary content item based on a detected user return event. The system may include at least one memory used to store data, such as computing instructions; and at least one processor coupled to the at least one memory and configured to perform operations including detecting a user return event; pre-fetching and pre-buffering a secondary content item during an idle period preceding the user return event; and initiating a transition effect based on the user return event, the transition effect includes partially displacing a home screen interface and displaying the secondary content item in a defined region of a screen.

In some cases, a non-transitory computer-readable storage medium is provided for delivering a secondary content item based on a detected user return event. In some instances, the non-transitory computer-readable medium comprising at least one instruction for causing at least one computing device to perform operations including detecting a user return event; pre-fetching and pre-buffering a secondary content item during an idle period preceding the user return event; and initiating a transition effect based on the user return event, the transition effect includes partially displacing a home screen interface and displaying the secondary content item in a defined region of a screen.

### BRIEF DESCRIPTION OF THE FIGURES

The accompanying drawings are incorporated herein and form a part of the specification.

FIG. 1 illustrates a block diagram of a multimedia environment, according to some examples of the present disclosure.

FIG. 2 illustrates a block diagram of a streaming media device, according to some examples of the present disclosure.

FIG. 3 illustrates a block diagram of secondary content management system(s), according to some examples of the present disclosure.

FIG. 4 illustrates an example process for providing and/or identifying a secondary content item insertion opportunity and initiating a transition to display an secondary content item, according to some aspects of the disclosed technology.

FIG. 5 illustrates an example process for presenting a secondary content item, which can be configured for display based on a pre-defined criteria, such as a time of day or prior user interactions, according to some aspects of the disclosed technology.

FIG. 6 illustrates an example process for processing user interaction feedback associated with a secondary content item, according to some aspects of the disclosed technology.

FIG. 7 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Traditional over-the-top (OTT) home screen interfaces and/or content placement systems are limited in their capacity or ability to effectively deliver secondary content or secondary content item(s), such as advertisements or promotional media, without disrupting the user's experience or delaying access to primary content or primary content item(s) (e.g., movies, television shows, podcasts, videos, livestreams, etc.). As described herein, the home screen interface may be a graphical user interface or environment displayed by a device, such as a media device, that provides user(s) with access to available primary content item(s), applications, and/or system settings. In some instances, the home screen interface may be a default interface displayed upon startup, wake, and/or return from an idle state. Additionally, or alternatively, the home screen interface may include content listing(s) of the primary content item(s) available to the user, channel icons, and/or other user-selectable interface elements associated with content playback. The conventional OTT home screen interfaces and/or content placement systems typically trigger secondary content playback after explicit user navigation events, such as channel selection or application launch, which restricts exposure opportunities at high-traffic touchpoints, such as device boot, screen resume or screensaver dismissal, or channel entry. Moreover, conventional OTT home screen interfaces and/or content placement systems often rely on full-screen takeover formats that obscure the home screen interface and may create a jarring transition that interrupts user flow and may reduce engagement. Furthermore, conventional OTT home screen interfaces and/or content placement systems may fail to leverage idle or pre-engagement periods to pre-fetch and/or pre-buffer the secondary content item(s), which may result in playback latency and diminished impact of the secondary content item(s)' impact. The absence of contextual transition effects, dynamic sequencing and/or user-control features may further limit the ability of the conventional OTT home screen interfaces and/or content placement systems to achieve broader video reach and user engagement while maintaining a seamless user experience.

These limitations are particularly pronounced during high-traffic re-engagement moments or a user return event, such as, but not limited to, when users return to interact with the media device after inactivity. During a user return event, a user's attention may be naturally focused on the home screen interface. However, conventional systems, such as, the aforementioned OTT home screen interfaces and/or content placement systems, often lack mechanisms to detect this re-engagement or user return event as an opportunity for secondary content delivery. Moreover, without transitional cues that signal a temporary change in interface state of the home screen interface, users may perceive interstitial presentations as abrupt or intrusive. The result is a sub-optimal user experience and lower engagement performance for secondary content placements and/or the associated content delivery system.

Provided herein are system, apparatus, device, method and/or computer program product embodiments, and/or combinations and sub-combinations thereof (“systems and techniques” hereinafter), delivering secondary content items on a media device, such as a smart TV or streaming device, that dynamically engage users during user return event(s) or re-engagement event(s) while maintaining contextual awareness of the home screen interface. In some examples, the systems and techniques described herein may deliver the secondary content item(s) based on a detected user return event (e.g., device boot, dismissal of a screensaver, or entrance/exit from a first-party or third-party channel). In some instances, the systems and techniques described herein may detect the user return event. Based on the user return event, the systems and techniques described herein may initiate a transition effect to convey to the user that the home screen interface is temporarily transitioning to present the secondary content item(s). In some configurations, the transition effect may convey to the user that the home screen interface is temporarily transitioning to present the secondary content item(s), while maintaining the visual continuity of the home screen environment. The transition effect may include, but is not limited to, partially displacing the home screen interface displayed on a display device and/or displaying a secondary content item, such as a video or image, within defined region of the display device (e.g., a central region of the display device).

In some examples, the systems and techniques described herein may perform one or more operations or processes to pre-fetch and/or pre-buffer the secondary content item(s). In such examples, the systems and techniques described herein may perform the pre-fetching and/or pre-buffering operations within or during a predetermined time period after detection of the user return event. Additionally, or alternatively, the systems and techniques described herein may pre-fetch and/or pre-buffer the secondary content item(s) within or during a predetermined time period before the secondary content item is to be displayed or presented. By pre-loading or pre-buffering, the secondary content item(s) relative to the timing of the detected user return event, the systems and techniques described herein may reduce or eliminate playback delay and enhance the continuity of the user experience.

In some cases, the systems and techniques described herein may initiate one or more indication cues (e.g., an auditory cue and/or a visual cue). In some instances, the indication cue(s) may be synchronized with the transition effect to create a cohesive, perceptible progression from user re-engagement to secondary content playback while maintaining a seamless and non-disruptive user experience.

In some cases, the systems and techniques described herein may provide a user control interface to enable one or more user(s) to interact with and/or configure presentation parameters of the secondary content item(s), such as, but not limited to, skipping or closing the secondary content item after a defined threshold duration and opting out of secondary content autoplay through system settings. These interactive features may facilitate a balance between user control and content engagement, thereby promoting a more seamless and responsive home screen experience. In some instances, one or more interactive elements of the user control interface may be customized or adapted based on user preferences and/or historical interaction data.

In some aspects, the systems and techniques described herein may implement one or more operations or processes to enable time-based and/or behavior-based scheduling of secondary content item(s). For example, the systems and techniques described herein may schedule secondary content item(s) presentations during specific blocks of time, such as prime time (e.g., 6 PM to 10 PM or 11 PM, etc.), high-traffic re-engagement periods, and/or based on prior user interaction patterns, to maximize reach and optimize user experience.

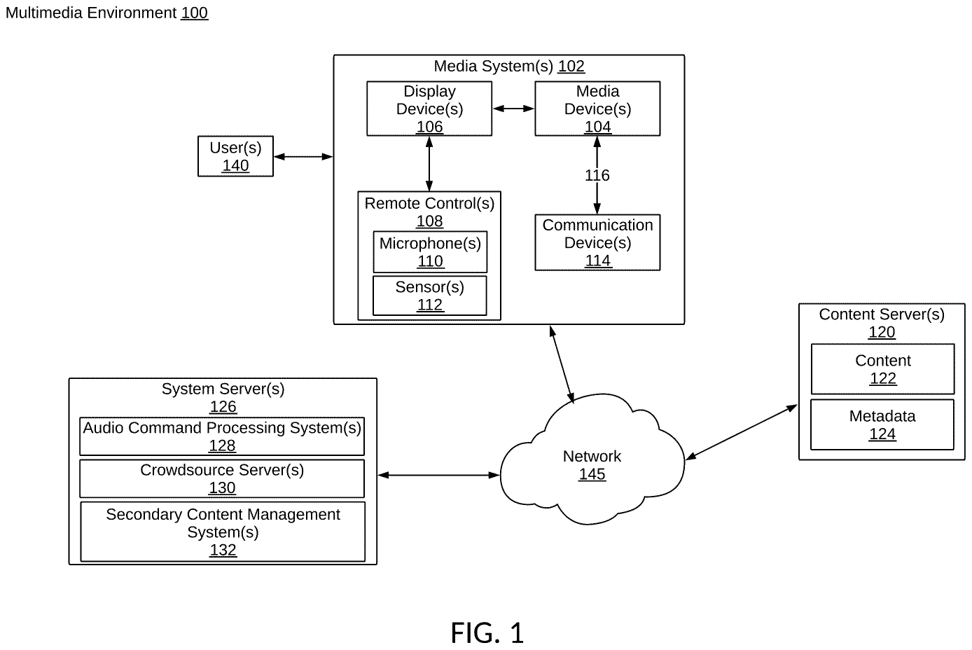

Various embodiments and aspects of this disclosure may be implemented using and/or may be part of a multimedia environment 100 shown in FIG. 1. It is noted, however, that multimedia environment 100 is provided solely for illustrative purposes and is not limiting. Examples and embodiments of this disclosure may be implemented using, and/or may be part of, environments different from and/or in addition to the multimedia environment 100, as will be appreciated by persons skilled in the relevant art(s) based on the teachings contained herein. An example of the multimedia environment 100 shall now be described.

### Mult Environment

FIG. 1 illustrates a block diagram of a multimedia environment 100, according to some embodiments. In a non-limiting example, multimedia environment 100 may be directed to streaming media. However, this disclosure is applicable to any type of media (instead of or in addition to streaming media), as well as any mechanism, means, protocol, method and/or process for distributing media.

The multimedia environment 100 may include one or more media systems 102. A media system 102 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 140 may operate with the media system 102 to select and consume content.

Each media system 102 may include one or more media devices 104 each coupled to one or more display devices 106. It is noted that terms such as “coupled,” “connected to,” “attached,” “linked,” “combined” and similar terms may refer to physical, electrical, magnetic, logical, etc., connections, unless otherwise specified herein.

Media device 104 may be a streaming media device, DVD or BLU-RAY device, audio/video playback device, cable box, and/or digital video recording device, to name just a few examples. Display device 106 may be a monitor, television (TV), computer, smart phone, tablet, wearable (such as a watch or glasses), appliance, internet of things (IoT) device, and/or projector, to name just a few examples. In some examples, media device 104 can be a part of, integrated with, operatively coupled to, and/or connected to its respective display device 106.

Each media device 104 may be configured to communicate with network 145 via a communication device 114. The communication device 114 may include, for example, a cable modem or satellite TV transceiver. The media device 104 may communicate with the communication device 114 over a link 116, wherein the link 116 may include wireless (such as WiFi) and/or wired connections.

In various examples, the network 145 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 102 may include a remote control 108. The remote control 108 can be any component, part, apparatus and/or method for controlling the media device 104 and/or display device 106, such as a remote control, a tablet, laptop computer, smartphone, wearable, on-screen controls, integrated control buttons, audio controls, or any combination thereof, to name just a few examples. In some examples, the remote control 108 wirelessly communicates with the media device 104 and/or display device 106 using cellular, Bluetooth, infrared, etc., or any combination thereof. The remote control 108 may include a microphone 110 and one or more sensors 112, which is further described below.

The multimedia environment 100 may include a plurality of content servers 120 (also called content providers, channels or sources 120). Although only one content server 120 is shown in FIG. 1, in practice the multimedia environment 100 may include any number of content servers 120. Each content server 120 may be configured to communicate with network 118.

Each content server 120 may store content 122 and metadata 124. Content 122 may include primary content or content items and secondary content or content items. As described herein primary content or content items may include, but are not limited to, any combination of music, videos, movies, TV programs, multimedia, images, still pictures, text, graphics, gaming applications, advertisements, programming content, public service content, government content, local community content, software, and/or any other content or data objects in electronic form. Moreover, secondary content or content items may include a content item provided by a third-party content provider, such as an advertisement.

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 100 may include one or more system servers 126. The system servers 126 may operate to support the media devices 104 and/or display device(s) 106 from a remote location and/or network, such as, a remote network, the cloud, a backend, a remote datacenter, etc. It is noted that the structural and functional aspects of the system servers 126 may wholly or partially exist in the same or different ones of the system servers 126.

In some examples, the system server(s) 126 may include, host, operate, and/or implement audio command processing system(s) 128, crowdsource server(s) 130, and/or secondary content management system(s) 132. The audio command processing system(s) 128 can process audio data such as speech/voice inputs and/or commands, audio/speech in videos, etc. For example, as noted above, the remote control(s) 108 may include a microphone(s) 110 that can receive audio data from user(s) 140 (as well as other sources, such as the display device(s) 106). In some examples, the media device(s) 104 may be audio responsive, and the audio data may represent verbal commands from the user(s) 140 to control the media device(s) 104 as well as other components in the media system(s) 102, such as the display device(s) 106.

Secondary content management system(s) 132 may implement or perform one or more operations or processes for delivering secondary content or secondary content item(s) (e.g., advertisements, promotional media, or other supplemental content) to one or more media device(s) 104 or display device(s) 106 of multimedia environment 100. In some examples, secondary content management system(s) 132 may operate in conjunction with system server(s) 126 to coordinate the detection of user re-engagement events, manage timing and sequencing of secondary content delivery, and control the display of the secondary content item(s) in a manner that maintains continuity of the home screen interface. As described herein, a home screen interface may refer to a graphical environment displayed by media device(s) 104 (e.g., a smart TV or streaming device) that provides access to primary content (e.g., movies, television shows, livestreams, or applications) and/or system settings. In some instances, the home screen interface may serve as the default display when the device boots, resumes from idle, or exits an application session.

In some examples, secondary content management system(s) 132 may detect one or more user return event(s). As described herein, a user return even may be a system-recognizable occurrence indicating a user's re-engagement with media device 104 and/or home screen interface after a period of inactivity or alternative operation. Examples of user return events may include, but are not limited to, a device boot, dismissal of a screensaver, resumption from a low-power or sleep state, or entrance to or exit from a first-party or third-party channel. In some instances, secondary content management system(s) 132 may deliver secondary content or secondary content item(s) (e.g., advertisements, promotional media, or other supplemental content) to one or more media device(s) 104 or display device(s) 106 of multimedia environment 100 based on the detected user return event.

In some cases, the one or more one or more operations or processes for delivering secondary content or secondary content item(s) (e.g., advertisements, promotional media, or other supplemental content) to one or more media device(s) 104 or display device(s) 106 of multimedia environment 100 may be associated with a transition effect. In such cases, secondary content management system(s) 132 may deliver secondary content or secondary content item(s) (e.g., advertisements, promotional media, or other supplemental content) to one or more media device(s) 104 or display device(s) 106 of multimedia environment 100 by implementing a transition effect. For example, secondary content management system(s) 132 may deliver secondary content or secondary content item(s) (e.g., advertisements, promotional media, or other supplemental content) to one or more media device(s) 104 or display device(s) 106 of multimedia environment 100 based on a detected user return event. As described herein, a transition effect may be a visual, auditory, or combined sensory presentation that conveys to the user that the home screen interface is temporarily transitioning to display the secondary content while maintaining visual continuity of the home screen environment. The transition effect may include, but is not limited to, partially displacing the home screen interface and/or presenting the secondary content item within a defined region of the display device (e.g., a central display area). In some examples, the transition effect may include a partial-screen animation or displacement effect that indicates a temporary shift in focus without obscuring the home screen context.

In some cases, secondary content management system(s) 132 may initiate one or more indication cues to signal the user to the commencement of the secondary content item to be presented. As described herein, the indication cue(s) may include an audio cue (e.g., a short chime or brief tone) and/or a visual cue (e.g., an ad slate or overlay displaying a contextually relevant message or brand identifier). The indication cue(s) may be synchronized with the transition effect to create a cohesive, perceptible progression from user re-engagement to secondary content playback while maintaining a seamless and non-disruptive user experience.

In some aspects, secondary content management system(s) 132 may perform one or more operations to pre-fetch and/or pre-buffer secondary content item(s) relative to the timing of the detected user return event. For example, secondary content management system(s) 132 may retrieve and buffer the secondary content during a predetermined time period after detecting a user return event, or during a predetermined interval prior to the scheduled presentation of the secondary content item. By pre-fetching and/or pre-buffering the secondary content item(s) in this manner, secondary content management system(s) 132 may minimize playback latency and enable seamless presentation once the transition effect is initiated.

In some instances, secondary content management system(s) 132 may provide a user control interface to one or more users, via display device(s) 106. The user control interface may enable the user(s) to interact with and/or configure presentation parameters of the secondary content item(s). The user control interface may enable actions such as skipping or closing the secondary content after a defined threshold duration, opting out of secondary content autoplay via system settings, interacting with companion or “leave-behind” elements on the home screen interface, and engaging with one or more call-to-action (CTA) elements (e.g., “Learn More,” “Sign Up,” or “Shop Now”). In some cases, one or more interactive elements of the user control interface may be customized or adapted based on user preferences and/or historical interaction data.

In some examples, secondary content management system(s) 132 may perform one or more operations to enable time-based and/or behavior-based scheduling of secondary content item(s). For example, secondary content management system(s) 132 may schedule presentations of secondary content during specific time blocks (e.g., prime-time intervals such as 6 PM to 10 PM), high-traffic re-engagement periods, or based on prior user activity patterns. By dynamically tailoring delivery based on temporal and behavioral signals, secondary content management system(s) 132 may enhance contextual relevance, increase audience reach, and optimize user engagement. Additionally, or alternatively, secondary content management system(s) 132 may apply rules or templates for custom message sequencing to allow advertisers to layer messaging and create contextually relevant, multi-stage experiences that align with user attention patterns.

In some configurations, secondary content management system(s) 132 may communicate with media device(s) 104, display device(s) 106, and content server(s) 120 via network 145 to coordinate the retrieval, buffering, and display of both primary and secondary content item(s). For example, secondary content management system(s) 132 may receive playback context data or device state information from media device 104 (e.g., home screen active state, idle duration, or user interaction history), request corresponding secondary content or metadata from content server 120, and transmit a playback instruction and/or transition effect trigger to display device 106 for rendering. In this manner, secondary content management system(s) 132 may operate as an orchestration layer that synchronizes content delivery operations across distributed components of multimedia environment 100, ensuring that secondary content item(s) are presented seamlessly in association with primary content playback or home screen re-engagement events.

In some examples, secondary content management system(s) 132 may exchange metadata describing network conditions, user engagement metrics, and/or contextual device states (e.g., idle duration or screensaver activation) to optimize subsequent secondary content delivery. For example, secondary content management system(s) 132 may receive latency or bandwidth data from media device 104 to determine an appropriate buffering strategy, collect engagement metrics such as skip rates or interaction frequency from display device 106, and aggregate contextual state information (e.g., time of day, content viewing duration, or recent application activity) to refine delivery timing and content selection. By utilizing this metadata, secondary content management system(s) 132 may dynamically adapt its pre-fetching intervals, transition effect parameters, and sequencing logic to enhance the continuity and responsiveness of future secondary content presentations.

In some examples, the crowdsource server(s) 130 of system server(s) 126 operate to cause closed captioning to be automatically turned on and/or off during streaming of a given media content or content item, such as a given movie. For example, using information received from the media devices 104 of media systems 102 (e.g., in thousands or millions of media systems), the crowdsource server(s) 130 may identify similarities and overlaps between closed captioning requests issued by different users 140 watching a particular movie. Based on such information, the crowdsource server(s) 130 may determine that turning closed captioning on may enhance users'140 viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 130 may operate to cause closed captioning to be automatically turned on and/or off during future streamings of the movie.

The system servers 126 may also include an audio command processing system 128. As noted above, the remote control 108 may include a microphone 110. The microphone 110 may receive audio data from users 140 (as well as other sources, such as the display device 106). In some examples, the media device 104 may be audio responsive, and the audio data may represent verbal commands from the user 140 to control the media device 104 as well as other components in the media system 102, such as the display device 106.

In some examples, the audio data received by the microphone 110 in the remote control 108 is transferred to the media device 104, which is then forwarded to the audio command processing system 128 in the system servers 126. The audio command processing system 128 may operate to process and analyze the received audio data to recognize the user 140's verbal command. The audio command processing system 128 may then forward the verbal command back to the media device 104 for processing.

Audio command processing system(s) 128, crowdsource server(s) 130, and/or secondary content management system(s) 132 can be part of, hosted at, and/or implemented by a same system server (or a same set of system servers) from the system server(s) 126 or different/separate system servers from the system server(s) 126. In some cases, secondary content management system(s) 132 can be part of, hosted at, and/or implemented by a same system server (or a same set of system servers) that is (or are) separate from a system server(s) that includes, implements, and/or hosts audio command processing system(s) 128 and/or the crowdsource server(s) 130. In some aspects, audio command processing system(s) 128, crowdsource server(s) 130 and/or secondary content management system(s) 132 can be implemented by or distributed across multiple and/or different system servers.

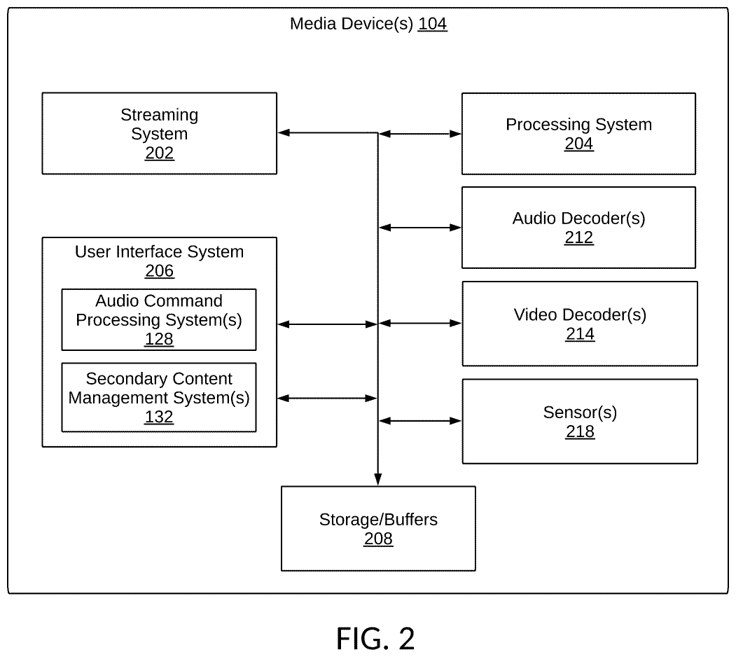

In some examples, the media device(s) 104 can include, implement, and/or host a respective copy or version of audio command processing system(s) 128, crowdsource server(s) 130 and/or secondary content management system(s) 132 as shown in FIG. 2. Moreover, audio command processing system(s) 128, crowdsource server(s) 130 and secondary content management system(s) 132 can each include, implement, and/or host one or more servers, computers, models and/or neural networks (e.g., artificial intelligence (AI) and/or machine learning (ML) models and/or neural networks, statistical models, etc.), algorithms, software applications, software engines, software modules, software services, software code/logic, software components, processors and/or processing circuitry (e.g., central processing units (CPUs), digital signal processors (DSPs), graphics processing units (GPUs), image signal processors (ISPs), microprocessors, processor cores, system-on-chip (SOC) devices, application-specific integrated circuits (ASICs), field-programmable gate arrays (FPGAs), integrated circuits, etc.), software and/or hardware elements, software platforms, and/or any other hardware and/or software components.

FIG. 2 illustrates a block diagram of an example media device 104, according to some embodiments. Media device 104 may include a streaming system 202, processing system 204, storage/buffers 208, and user interface module 206. As described above, the user interface module 206 may include the audio command processing system 128.

In some cases, the user interface module 206 may optionally include a copy or version of the audio command processing system(s) 128, such as a local copy or version of audio command processing system(s) 128. Moreover, the media device(s) 104 may optionally include a copy or version of the crowdsource server(s) 130, such as a local copy or version of crowdsource server(s) 130. In some cases, the media device(s) 104 may optionally include a copy or version of the secondary content management system(s) 128 and/or the secondary content management system(s) 132 to perform some or all of the operations, tasks, functions, and/or actions of the audio command processing system(s) 128, crowdsource server(s) 130, and/or secondary content management system(s) 132.

For example, the media device(s) 104 may optionally include a copy or version of audio command processing system(s) 128, and/or secondary content management system(s) 132 to allow media device(s) 104 to perform any of the tasks, operations, functions, etc., described herein with respect to audio command processing system(s) 128 and/or secondary content management system(s) 132 (e.g., in addition to or instead of any of such tasks, operations, functions, etc. (or portions thereof), performed by the audio command processing system(s) 128 and/or secondary content management system(s) 132 at/from system server(s) 126 shown in FIG. 1).

In some implementations, the audio command processing system(s) 128, crowdsource server(s) 130, and/or secondary content management system(s) 132 can be optionally included in, implemented by, hosted at, and/or part of the user interface module 206. Moreover, in some implementations secondary content management system(s) 132, can be optionally included in, implemented by, hosted at, and/or part of the processing system 204. In some cases, the audio command processing system(s) 128 optionally included in the user interface module 206 in FIG. 2 can be the same as the audio command processing system(s) 128 at/from the system server(s) 126 in the multimedia environment 100 shown in FIG. 1. In other cases, the audio command processing system(s) 128 optionally included in the user interface module 206 in FIG. 2 can be a version of the audio command processing system(s) 128 at/from the system server(s) 126 in the multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of the audio command processing system(s) 128 at/from system server(s) 126 in FIG. 1.

In some cases, secondary content management system(s) 132 optionally included in the media device(s) 104 in FIG. 2 can be the same as secondary content management system(s) 132 at/from the system server(s) 126 in the multimedia environment 100 shown in FIG. 1. In other cases, secondary content management system(s) 132 may be optionally included in the media device(s) 104 in FIG. 2 can be a version of secondary content management system(s) 132 at/from the system server(s) 126 in the multimedia environment 100 shown in FIG. 1, such as a local version, a client version, a standalone version, and/or a lighter version (e.g., a smaller version having a smaller data size; a version with less components, features, functions, modules, libraries, and/or capabilities; a version with less code or a smaller package of code; etc.) of secondary content management system(s) 132 at/from system server(s) 126 in FIG. 1.

The media device 104 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, VVC, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, VVC, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

The media device(s) 104 may also include one or more sensors 218. Examples of sensors 218 include but are not limited to image/optical sensors, accelerometers, gyroscopes, inertial measurement units (IMUs), light sensors, magnetic sensors, positioning sensors (e.g., GNSS), biometric sensors, any other type of sensor, and/or any combination thereof. For example, sensors 218 may correspond to an image sensor of an extended reality device that can be configured to capture image data and/or video data of an environment. For instance, media device(s) 104 can include an infrared (IR) light source, visible light source, laser source, or the like.

Now referring to both FIGS. 1 and 2, in some examples, the user 140 may interact with the media device 104 via, for example, the remote control 108. For example, the user 140 may use the remote control 108 to interact with the user interface module 206 of the media device 104 to select a primary content item, such as a movie, TV show, music, book, application, game, etc. The streaming system 202 of the media device 104 may request the selected primary content item from the content server(s) 120 over the network 145. The content server(s) 120 may transmit the requested primary content item to the streaming system 202. The media device 104 may transmit the received primary content item to the display device 106 for playback to the user 140.

In streaming examples, the streaming system 202 may transmit the content to the display device 106 in real time or near real time as it receives such primary content item from the content server(s) 120. In non-streaming examples, the media device 104 may store the content received from content server(s) 120 in storage/buffers 208 for later playback on display device 106.

Referring to FIG. 1, the media devices 104 may exist in thousands or millions of media systems 102. Accordingly, the media devices 104 may lend themselves to crowdsourcing embodiments. In some examples, one or crowdsource servers 130 in the system servers 126 operate to cause closed captioning to be automatically turned on and/or off during streaming of a given movie.

For example, using information received from the media devices 104 in the thousands and millions of media systems 102, the crowdsource server(s) 130 may identify similarities and overlaps between closed captioning requests issued by different users 140 watching a particular movie. Based on such information, the crowdsource server(s) 130 may determine that turning closed captioning on may enhance users'viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 130 may operate to cause closed captioning to be automatically turned on and/or off during future streamings of the movie.

### Secondary Content Management System(s)

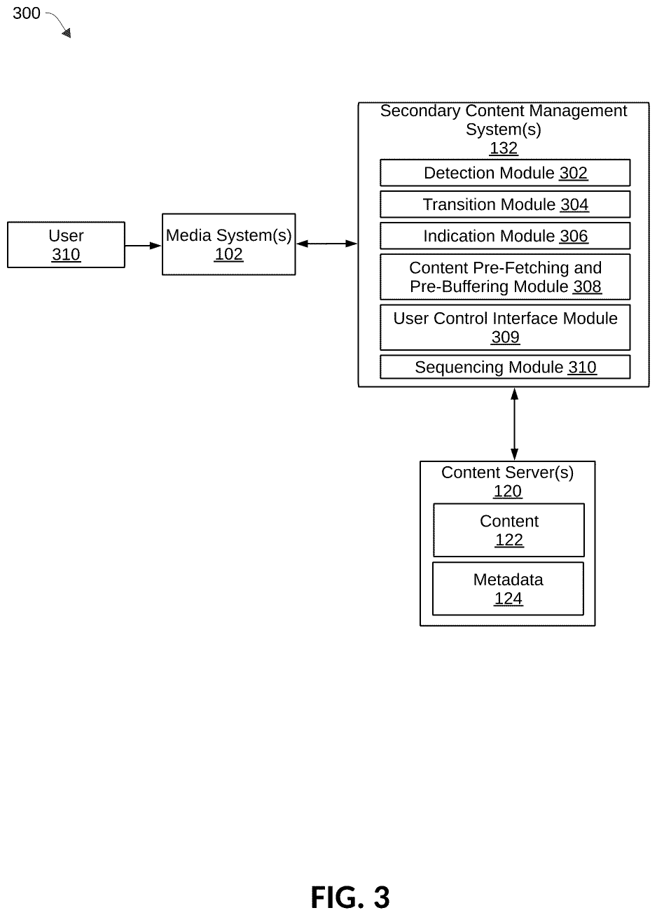

FIG. 3 illustrates a block diagram of secondary content management system(s) 132. As described herein, secondary content management system(s) 132 may implement one or more operations for coordinating the delivery, presentation, and/or management of secondary content or secondary content item(s) (e.g., advertisements, promotional media, or other supplemental content) within multimedia environment 100. In some examples, secondary content management system(s) 132 may operate in conjunction with system server(s) 126 to detect user re-engagement events, determine timing conditions for secondary content delivery, and/or manage presentation transitions in a manner that maintains continuity of the home screen interface.

As described herein, secondary content management system(s) 132 may detect one or more user return event(s). A user return event may be a system-recognizable occurrence that indicates a user's re-engagement with media device 104 and/or the home screen interface after a period of inactivity or alternate device operation. Examples of user return events may include, but are not limited to, a device boot, dismissal of a screensaver, resumption from a low-power or sleep state, or entrance to or exit from a first-party or third-party channel. Based on detecting a user return event, secondary content management system(s) 132 may initiate one or more operations to deliver secondary content item(s) (e.g., advertisements, promotional media, or other supplemental content) to one or more media system(s) 102 (e.g., media device(s) 104 and/or display device(s) 106) of multimedia environment 100.

In some cases, secondary content management system(s) 132 may deliver secondary content item(s) by implementing a transition effect. As described herein, a transition effect may refer to a visual, auditory, or combined sensory presentation that conveys to the user that the home screen interface is temporarily transitioning to display secondary content while maintaining visual continuity of the home screen environment. The transition effect may include, but is not limited to, partially displacing the home screen interface and/or presenting the secondary content item within a defined region of the display device (e.g., a central display area). In some examples, the transition effect may involve a partial-screen animation or displacement effect that indicates a temporary shift in focus without obscuring the underlying home screen context. Additionally, or alternatively, the transition effect may include one or more audio or visual cues, such as a short chime or introductory slate, to signal commencement of the secondary content presentation.

In some examples, secondary content management system(s) 132 may perform one or more operations to pre-fetch and/or pre-buffer secondary content item(s) relative to the timing of the detected user return event. For example, secondary content management system(s) 132 may retrieve and buffer secondary content item(s) during a predetermined time period after detecting a user return event or during a predetermined time period before the scheduled presentation of the secondary content item.

In some aspects, secondary content management system(s) 132 may provide a user control interface via display device(s) 106 to enable one or more user(s) to interact with and/or configure presentation parameters of the secondary content item(s). The user control interface may enable actions such as skipping or closing the secondary content after a defined threshold duration, opting out of secondary content autoplay via system settings, interacting with companion or “leave-behind” elements on the home screen interface, and engaging with one or more call-to-action (CTA) elements (e.g., “Learn More,” “Sign Up,” or “Shop Now”). In some instances, one or more interactive elements of the user control interface may be customized or adapted based on user preferences and/or historical interaction data.

In some instances, secondary content management system(s) 132 may implement time-based and/or behavior-based scheduling of secondary content item(s). For example, secondary content management system(s) 132 may schedule presentation of secondary content during specific time blocks (e.g., prime-time intervals such as 6 PM to 10 PM), high-traffic re-engagement periods, or based on prior user activity patterns. Additionally, or alternatively, secondary content management system(s) 132 may apply rules or templates for custom message sequencing that allow advertisers to layer messaging and create contextually relevant and multi-stage experiences aligned with user attention patterns.

As illustrated in FIG. 3, secondary content management system(s) 132 may include one or more modules or subsystems that are configured to perform one or more of the operations and capabilities described herein. These module(s) may include, but are not limited to, detection module 302, transition module 304, and indication module 306. In some configurations, secondary content management system(s) 132 may include additional modules to support to extend its operational capabilities. These additional module(s) may include, but are not limited to, content pre-fetching and pre-buffering module 308, user control interface module 309, and sequencing module 310.

Detection module 302 may implement one or more operations for detecting one or more user return event(s) associated with a user's re-engagement with a media system 102 or media device 104. In some examples, detection module 302 may be configured to identify and classify user re-engagement at various high-traffic touchpoints, such as when the user returns to the smart TV after being idle (e.g., dismissal of a screensaver), when the device boots up, or when the user exits a first-party or third-party channel and returns to the home screen interface. Moreover, detection module 302 may generate user return event data identifying and characterizing the user return event detected by detection module 302. In some cases, the user return event data may include a timestamp for each identified and characterized detected user return event. The timestamp may indicate a time or time interval the user return event was detected.

In some cases, detection module 302 may communicate with one or more components of media system 102 (e.g., media device 104, display device 106, and/or system server(s) 126) to obtain device data indicative of user return event information. The device data may include information identifying and/or characterizing one or more states, activities, or transitions of media device 104 relative to the home screen interface. In some examples, the device data may include timestamps associated with a detected user return event, allowing detection module 302 to characterize the timing, frequency, and context of the user's re-engagement.

For example, detection module 302 may communicate with media device 104 to obtain device data associated with media device 104. Based on the device data, detection module 302 may determine user has powered on their smart TV for the first time that day at a particular time (e.g., based on the timestamp included in the device data). Moreover, detection module 302 may generate user return event data identifying and characterizing the user return event detected by detection module 302 (e.g., the user powered on their smart TV for the first time that data at the particular time). Further, detection module 302 may implement subsequent operation(s) related to providing one or more secondary content item(s) to the user via media device 104 (e.g., initiation of a transition effect or pre-fetching of a secondary content item).

In some examples, the device data may include on-screen data. The on-screen data may include data describing the current visual or operational state of display device 106 communicating with media device 104. For example, the on-screen data may indicate whether a primary content item (e.g., a movie, television show, podcast, video, or livestream) is currently being displayed, or whether the display device 106 is presenting the home screen interface. Additionally, or alternatively, on-screen data may include data characterizing the content of the primary content item currently being displayed on the display device, such as digital fingerprints, closed caption data, channel metadata, and/or other content-related information. Detection module 302 may use the on-screen data to identify transitions between content types or viewing modes, such as a user exiting a third-party streaming channel or application and returning to the home screen interface.

In some instances, the on-screen data may indicate the presence or absence of visual interface elements on display device 106. In such instances, detection module 302 may determine the presence or absence of visual interface elements on display device 106 to further confirm the occurrence of a user return event. For example, detection module 302 may identify a shift from a content playback interface (e.g., a video player associated with a streaming application) to the home screen interface of the media device 104. In some configurations, detection module 302 may further classify user return events based on contextual factors, such as time of day, device state, or frequency of prior engagement, and may tag each detected event with corresponding metadata (e.g., device ID, event type, timestamp). The detected user return event(s) may then be communicated to transition module 304 and/or other components of secondary content management system(s) 132 to initiate one or more subsequent operations for delivering secondary content item(s). For example, detection module 302 may provide the user return event data to transition module 304 and/or other components of secondary content management system(s) 132 to initiate one or more subsequent operations for delivering secondary content item(s).

Transition module 304 may implement one or more operations or processes for initiating and/or managing a transition effect associated with the presentation of secondary content or secondary content item(s) (e.g., advertisements, promotional media, or other supplemental content). In some examples, transition module 304 may receive user return event data from detection module 302 identifying and characterizing a detected user return event, and in some instances, a corresponding timestamp. Based on the user return event data, transition module 304 may determine a user event data was detected and, in some instances, the corresponding timestamp. Based on the detected user return event, transition module 304 may initiate one or more operations for a transition effect to introduce or display the corresponding secondary content item(s) to a user via media system 102 (e.g., media device(s) 104 and/or display device(s) 106) of multimedia environment 100.

As described herein, a transition effect may refer to a visual, auditory, or combined sensory presentation that conveys to the user that the home screen interface is temporarily transitioning to display secondary content while maintaining the visual continuity of the home screen environment. Transition module 304 may initiate the transition effect to perform one or more functions including, but not limited to, partially displacing the home screen interface, and/or displaying the secondary content item within a defined region of display device 106 (e.g., a central display area). The transition effect may be configured to capture the user's attention while keeping the experience integrated within the overall home screen context. Unlike conventional full-screen advertisements that completely replace the home screen view, this partial displacement preserves user orientation and promotes a cohesive and minimally disruptive experience.

In some examples, transition module 304 may use device data obtained from detection module 302 to determine where on display device 106 to position or render the secondary content item. As described herein, the device data may include on-screen data. For instance, the on-screen data may identify available region(s) of display device 106. In some instances, an available region may not include interface elements of the home screen interface (e.g., navigation bars or channel icons). Based on the identified available region(s), transition module 304 may dynamically adjust the placement of a video advertisement to the central region of display device 106 while preserving visibility of key contextual interface elements surrounding the playback area. For example, upon receiving from detection module 302 an indication that a user has powered on their smart TV for the first time that day, transition module 304 may initiate a partial-screen transition in which the home screen interface slides downward to reveal the secondary content item in a central portion of the screen. This controlled displacement enables the advertisement to be introduced naturally as part of the user's re-engagement experience.

Examples of transition effect(s) transition module 304 may support, include, but are not limited to, a dimming effect (e.g., the brightness of the background home screen is reduced to emphasize the secondary content item to be presented or is being presented), a slide effect (e.g., interface elements shift laterally or vertically to create space for the secondary content item), a blur effect (e.g., the underlying home screen interface is blurred while the secondary content item remains in focus), a zoom-out effect (e.g., the home screen interface scales outward to reveal the secondary content item to be played in a central display region), a fade-out effect (e.g., peripheral interface elements of the home screen interface gradually fade to focus attention on the advertisement), and a partial overlay effect (e.g., the advertisement is presented with a semi-transparent overlay such that both the secondary content item and the home screen interface remain simultaneously visible). As described herein, transition module 304 may select the transition effect to be presented based on contextual information, such as, but not limited to time of day, user preferences, advertiser configuration, and/or real-time device performance conditions (e.g., rendering capability, processor load, or available memory). In some examples, the contextual information may be obtained from one or more sources, including device data received from media device 104, system settings or user profile data stored in system server(s) 126, secondary content specified parameters associated with a secondary content item or secondary content, and/or operational telemetry provided by media system 102 (e.g., performance metrics, device logs, or network diagnostics). Transition module 304 may use the contextual information to dynamically determine and apply an appropriate transition effect that optimizes the visual presentation of the secondary content while maintaining performance efficiency and a consistent user experience across different device configurations.

In some configurations, transition module 304 may also determine the complexity or intensity of a transition effect based on device performance parameters. For example, on media device(s) 104 and/or display device(s) 106 with limited processing capability, transition module 304 may automatically select a simplified effect (e.g., a fade-out effect or slide effect) to ensure smooth rendering performance. Conversely, on media device(s) 104 and/or display device(s) 106 with greater rendering capability, transition module 304 may employ more elaborate transition effects, such as a blur effect or zoom-based animations, to enhance the visual appeal of the experience.

Indication module 306 may implement one or more operations or processes for initiating and/or managing an indication cue that signals the commencement of a secondary content presentation. In some examples, indication module 306 may receive user return event data from detection module 302. Based on the user return event data, indication module 306 may determine a user return event has been detected, and, in some instances, a corresponding timestamp. Additionally, or alternatively, indication module 306 may receive transition initiation data from transition module 304 indicating secondary content item is scheduled or ready for presentation. Based on the detected user return event, and, in some instances, the corresponding timestamp, and/or the transition initiation data, indication module 306 may determine that the delivery of a secondary content item is imminent and initiate one or more indication operations to subtly alert the user of the forthcoming playback. The indication operation(s) may include generating an indication cue, such as, but not limited to, an audio cue, a visual cue, or a combination thereof.

As described herein, an indication cue may serve as a sensory pre-signal that communicates the start or impending start of the display, presentation or play back of a secondary content item. The indication cue may include, but is not limited to, a short audio chime, tone, or brief jingle, a visual ad slate or overlay displayed on display device 106, or any combination of both. In some examples, the visual cue may correspond to an ad slate that presents a contextually relevant message, logo, or brand identifier within or adjacent to the playback region of the secondary content item. By way of example, indication module 306 may initiate playback of a short, pleasant audio tone while simultaneously displaying a branded overlay that fades in around the central playback area. This subtle indication allows the user to recognize that the media device 104 is transitioning into a secondary content experience, while maintaining continuity and familiarity of the home screen interface.

In some configurations, indication module 306 may determine how to implement the indication cue, such as whether to present an audio cue, a visual cue, or a combination thereof, based on contextual information and device data. The contextual information may include, but is not limited to, time of day, user preferences, advertiser configuration parameters, and/or device performance metrics (e.g., audio output state, rendering capability, processor load, or network bandwidth). The device data may be obtained from media device 104, display device 106, or system server(s) 126, and may include user return event data received from detection module 302, on-screen data, and/or operational telemetry associated with media system 102.

For example, detection module 302 may determine that a user has powered on their smart TV for the first time that day and provide corresponding user return event data to indication module 306. The user return event data generated by detection module 302 and/or device data associated with the smart TV may include contextual information, such as a timestamp indicating the time of day (e.g., early morning hours) and device performance parameters (e.g., available rendering resources or audio output readiness), respectively. Indication module 306 may obtain the user return event data from detection module 302 and/or the device data from the smart TV. Based on the user return event data and/or the device data, indication module 306 may determine the contextual information. Based on this contextual information, indication module 306 may determine and/or one or more indication cues to present, such as, a soft visual fade-in ad slate and a brief chime. As described herein, the selected indication cue(s) may subtly introduce the secondary content item while aligning with the user's re-engagement context (e.g., the context information). Indication module 306 may then implement the selected indication cue(s), such as initiating playback of the chime and rendering the visual ad slate on display device 106.

In some examples, a visual cue of an indication cue may correspond to a dynamically configurable ad slate or overlay that displays contextually relevant messages or graphics around the playback area of the video advertisement. Indication module 306 may obtain and apply configuration parameters for the ad slate from secondary content item defined metadata, user engagement metrics (e.g., historical interaction frequency or viewing duration), or server-provided campaign data managed by system server(s) 126. For example, a secondary content item provider may specify a visual slate layout that emphasizes a seasonal promotion during prime-time hours. Indication module 306 may automatically select a lighter, text-based variant for low-bandwidth or low-brightness environments. By dynamically adjusting the indication cue based on context information, indication module 306 can enhance the presentation of the secondary content item while maintaining a consistent and non-intrusive user experience.

Additionally, or alternatively, indication module 306 may adapt the complexity or style of the indication cue based on real-time device performance conditions. For example, for a media device 104 and/or display device 106, with limited processing capability, indication module 306 may select a simplified indication cue, such as a static visual banner or single-tone chime, to ensure smooth playback. Conversely, for a media device 104 and/or display device 106 with greater processing capability, indication module 306 may employ more sophisticated indication cues (e.g., multi-layer audio tones or animated visual slates) that enrich the sensory experience.

In some configurations, transition module 304 and indication module 306 may communicate with one another to synchronize the presentation of one or more indication cue(s) with the initiation of the transition effect to create a cohesive and continuous progression from user re-engagement to secondary content playback. In such configurations, transition module 304 may transmit transition-state data to indication module 306. Transition-state data may indicate that a transition effect is to be initiated at a particular time or timeframe, has been initiated or is in progress. Based on the transition-state data, indication module 306 may determine a predetermined time period within which to present the indication cue following the initiation of the transition effect. The predetermined time period may be defined by configuration parameters stored in system server(s) 126, by advertiser-defined playback rules, or by adaptive timing logic responsive to contextual information (e.g., device performance metrics, rendering latency, or network conditions). For example, after transition module 304 initiates a partial-screen displacement of the home screen interface to reveal a central display region, indication module 306 may wait a predefined interval (e.g., one to two seconds) before presenting a visual ad slate or brief chime that signals the commencement of the secondary content item. This timed coordination ensures that the user perceives a seamless and natural sequence in which the home screen interface transition, the indication cue, and the playback of the secondary content are experienced as part of a unified interaction.

Content pre-fetching and pre-buffering module 308 may implement one or more operations or processes for retrieving, pre-loading, and/or buffering secondary content item(s) (e.g., advertisements, promotional media, or other supplemental content). In some examples, content pre-fetching and pre-buffering module 308 may implement the operation(s) based on an anticipation of or relative to a detected user return event. In such examples, content pre-fetching and pre-buffering module 308 may receive user return event data from detection module 302 identifying a detected user return event and, in some instances, a corresponding timestamp. Based on the user return event data, content pre-fetching and pre-buffering module 308 may determine the user return event was detected, and, in some instances the corresponding timestamp. Based on such information, content pre-fetching and pre-buffering module 308 may initiate one or more operations to pre-fetch and/or pre-buffer a secondary content item within or during a predetermined time period relative to the detected user return event.

For example, content pre-fetching and pre-buffering module 308 may retrieve and buffer a secondary content item during an idle period preceding the user's re-engagement, such as, while the media device 104 is in a standby or low-power state, to ensure that the secondary content item is ready for immediate playback once the transition effect is triggered. Additionally, or alternatively, content pre-fetching and pre-buffering module 308 may initiate retrieve and buffer a secondary content item during a defined time interval after the detection of the user return event, allowing content pre-fetching and pre-buffering module 308 to synchronize buffering completion with the initiation of the transition effect and indication cue.

Additionally, or alternatively, content pre-fetching and pre-buffering module 308 may communicate with transition module 304 to receive transition-state data indicating that a transition effect has been scheduled, initiated, or is in progress. Based on the transition-state data, content pre-fetching and pre-buffering module 308 may adjust the timing and priority of buffering operations to ensure that the secondary content item is fully loaded prior to the display of the transition effect or the commencement of playback. For example, based on transition-state data indicating that a transition effect is scheduled to begin within a predetermined window (e.g., within one to two seconds), content pre-fetching and pre-buffering module 308 may allocate higher bandwidth or processing priority to finalizing content buffering.

For example, detection module 302 may determine that a user has powered on their smart TV for the first time that day. Moreover, detection module 302 may generate and transmit corresponding user return event data (e.g., including a timestamp and device state indicator) to content pre-fetching and pre-buffering module 308 and transition module 304. Based on the user return event data, transition module 304 may generate transition-state data indicating that a transition effect is scheduled to begin within a predetermined time window. Further, transition module 304 may provide the transition-state data to content pre-fetching and pre-buffering module 308. Based on the user return event data and/or the transition-state data, content pre-fetching and pre-buffering module 308 may prioritize the retrieval and/or buffering of a secondary content item, such as a 15-second video advertisement, within the predetermine time window (e.g., two seconds before the scheduled transition effect). For instance, content pre-fetching and pre-buffering module 308 may access a content delivery network (CDN) or content server 120 to begin fetching video ad segments while simultaneously referencing network diagnostic data from media device 104 (e.g., available bandwidth or Wi-Fi signal strength) to determine the optimal pre-buffer size. In some instances, if the network conditions indicate reduced throughput, content pre-fetching and pre-buffering module 308 may adjust the initial resolution of the video ad (e.g., lower the initial resolution of the video ad) to ensure that playback can begin immediately once the transition effect completes, while additional frames are fetched in the background.

In some cases, content pre-fetching and pre-buffering module 308 may also reference predictive interaction timing data or engagement analytics provided by system server(s) 126 to determine whether the user's current interaction pattern aligns with typical re-engagement behavior (e.g., booting the device in the morning during a daily viewing session). Using this data, content pre-fetching and pre-buffering module 308 may adjust the caching logic (e.g., prioritizing pre-buffering of shorter, high-impact video ads during brief idle states or pre-fetching longer ads when extended engagement periods are anticipated) of the content pre-fetching and pre-buffering module 308.

User control interface module 309 may implement one or more operations or processes for generating, presenting, and/or managing a user control interface associated with secondary content item(s) (e.g., advertisements, promotional media, or other supplemental content). In some examples, user control interface module 309 may operate in coordination with transition module 304 and indication module 306 to present interactive elements on the home screen interface of display device 106. The interactive elements may enable one or more users 140 to interact with, control, or configure presentation parameters of the secondary content item(s) while maintaining the continuity and contextual awareness of the home screen environment.

As described herein, the user control interface may include one or more interactive elements configured to provide user control options such as, but not limited to, skipping or closing the secondary content item, opting out of automatic secondary content playback via system settings, and interacting with companion and/or “leave-behind” elements displayed within existing home screen placements (e.g., a marquee ad slot or a spotlight ad region). The user control interface may include one or more call-to-action (CTA) elements associated with the secondary content item (e.g., “Learn More,” “Sign Up,” or “Shop Now”). In some configurations, these CTA elements may be presented within or adjacent to the playback area of the secondary content item, forming an integrated portion of the user control interface that allows immediate user engagement without interrupting the navigation flow.

In some cases, user control interface module 309 may determine when to activate or enable one or more interactive elements based on timing thresholds, contextual information, and/or device data. For example, a “Skip” button may be enabled after a predefined playback duration (e.g., five seconds), or a “Close” button may appear once the secondary content item has completed playback. The timing thresholds may be defined by configuration parameters stored in system server(s) 126 or provided by the secondary content item provider associated with the secondary content item. User control interface module 309 may further retrieve contextual information (e.g., user preferences, historical interaction data, or engagement metrics) from system server(s) 126 to adapt the layout, appearance, or functionality of the user control interface to enhance usability and compliance with advertiser-defined presentation rules.

In some aspects, user control interface module 309 may coordinate with detection module 302 to determine when to render the user control interface relative to a detected user return event. For example, detection module 302 may determine that the user has powered on their smart TV for the first time that day and may provide corresponding user return event data to user control interface module 309. Based on the user return event data, user control interface module 309 may determine a user return event has been detected, and in some instances, the corresponding timestamp. Additionally, or alternatively, user control interface module 309 may obtain transition-state data from transition module 304 (e.g., indicating that a transition effect is scheduled, initiated, or in progress) and data characterizing the indication cue from indication module 306 (e.g., timing information associated with the presentation of the indication cue(s)). Based on the user return event data, transition-state data, and/or data characterizing the indication cue, user control interface module 309 may determine the appropriate timing to render the interactive elements of the user control interface on the home screen interface once the secondary content item begins playback. For instance, user control interface module 309 may display a soft-fade “Skip” button in the lower-right region of the home screen interface that becomes active after a defined threshold (e.g., five seconds) and a “Close”button once the secondary content item concludes.

Sequencing module 310 may implement one or more operations or processes for scheduling, organizing, and/or sequencing the presentation of secondary content item(s) (e.g., advertisements, promotional media, or other supplemental content) based on temporal conditions, behavioral patterns, and/or contextual parameters. In some examples, sequencing module 310 may operate in coordination with detection module 302, transition module 304, and indication module 306 to determine when and how to deliver secondary content item(s) based on user engagement patterns and system-defined timing conditions. Sequencing module 310 may use this information to create a delivery schedule that ensures the presentation of secondary content item(s) occurs at contextually appropriate and high-impact moments, such as, but not limited to, upon user re-engagement, during prime-time intervals, and/or in response to recurring usage patterns.

As described herein, sequencing module 310 may determine when to present secondary content item(s) based on predefined time windows (e.g., 6 PM to 10 PM), user interaction history, and/or predictive engagement patterns. In some configurations, sequencing module 310 may retrieve and process one or more types of data to determine such user interaction history or predictive engagement patterns. Examples of the data may include, but are not limited to, user return event data received from detection module 302 (e.g., indicating the timing and frequency of device re-engagement events), contextual usage data obtained from media device 104 (e.g., viewing duration, idle time, or application switching patterns), and secondary content configuration data retrieved from system server(s) 126 (e.g., secondary content item provider- defined sequencing templates, frequency caps, or message rotation logic). Sequencing module 310 may process these data sources individually or in combination to generate and/or refine user interaction histories and predictive engagement patterns.

In some examples, sequencing module 310 may refine or optimize the sequencing, timing and/or prioritization of secondary content(s) for presentation or delivery over time based on engagement metric(s) or parameter(s) of a user (e.g., user 140). As described herein, sequencing module 310 may determine the engagement metric(s) or parameter(s) of the user based on the user interaction history, and/or predictive engagement patterns of the user. The engagement analytics may include, but are not limited to, metrics such as click-through rates, skip frequency, dwell time, or completion rates associated with prior secondary content presentations. In some configurations, sequencing module 310 may obtain the engagement metric(s) or parameter(s) from system server(s) 126. System server(s) 126 may aggregate data, such as, data related to user interaction history and/or predictive engagement patters, collected from one or more media devices 104 and display devices 106 associated with the user over a period of time. Sequencing module 310 may use the engagement metric(s) or parameter(s) to adaptively modify delivery parameters, such as, but not limited to, prioritization order, playback frequency, and content diversity thresholds, to improve user engagement and optimize secondary content exposure in subsequent user sessions.

For example, detection module 302 may determine that the user has powered on their smart TV for the first time that day and may transmit corresponding user return event data to sequencing module 310. Based on this user return event data and the associated timestamp (e.g., 8:00 PM local time), sequencing module 310 may process secondary content configuration data and/or engagement metric(s) or parameter(s) obtained from system server(s) 126. For instance, sequencing module 310 may determine, based on the engagement metric(s) or parameter(s) associated with the user (e.g., user 140), that the user typically interacts most with entertainment-related advertisements during evening hours. Moreover, sequencing module 310 may determine prime-time promotional content is to be prioritized between 6 PM and 10 PM based on the secondary content configuration data. Based on such determinations, sequencing module 310 may determine that a 15-second promotional advertisement for a new series should be delivered first, followed by a companion short-form advertisement related to the same campaign upon the user's next re-engagement. In some instances, sequencing module 310 may further coordinate with transition module 304 and indication module 306 to ensure that the selected secondary content item(s) are introduced smoothly through transition effects and indication cues consistent with the user's current session state and engagement preferences.

In some configurations, sequencing module 310 may apply rules or templates for multi-stage messaging that allow secondary content item providers to layer related secondary content item(s) across multiple user sessions based on engagement metric(s) or parameter(s) associated with the user. For example, a first secondary content item presented during a user's initial daily session may introduce a product or service, while a subsequent secondary content item displayed later in the same day may reinforce the message or present an updated promotional offer. Sequencing module 310 may retrieve the engagement metric(s) or parameter(s), as well as the secondary content item provider defined sequencing templates and timing rules, from system server(s) 126. System server(s) 126 may aggregate such data across one or more media devices 104 and display devices 106 associated with the user over a period of time. By integrating temporal, behavioral, and engagement-based data, sequencing module 310 ensures that secondary content item(s) are delivered in a manner that is contextually relevant, minimally intrusive, and dynamically tailored to the user's observed interaction history and predictive engagement patterns.

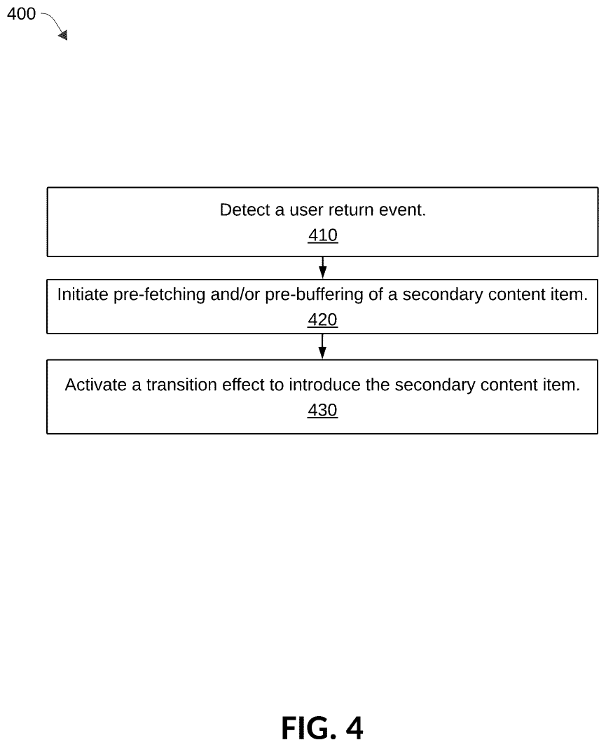

FIG. 4 is a flowchart for a method 400 for providing identifying a secondary content item insertion opportunity and initiating a transition to display a secondary content item, according to some aspects of the disclosed technology. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to that example. In step 410, secondary content management system(s) 132 may detect a user return event. The user return event may include, but is not limited to, various high-traffic touchpoints, such as when the user returns to the smart TV after being idle (e.g., when the screensaver is dismissed), the device boots up, or the user exits a first-party or third-party channel and returns to the home screen interface. As described herein, secondary content management system(s) 132 may initiate one or more operations to deliver secondary content item(s) (e.g., advertisements, promotional media, or other supplemental content) to one or more media system(s) 102 (e.g., media device(s) 104 and/or display device(s) 106) of multimedia environment 100 based on the detected user return event. In some instances, secondary content management system(s) 132 may generate user return event data identifying and characterizing the detected user return event, and in some instances, a corresponding timestamp.

For example, detection module 302 may determine that the user has returned to the home screen interface after the device exited a screensaver mode following an idle period of several minutes. Moreover, detection module 302 may generate user return event data identifying and characterizing the user return event. Further, the user return event data may include a timestamp corresponding to the time of the screensaver dismissal (e.g., 7:45 PM local time) and/or a device state indicator identifying that the media device 104 has transitioned from idle to active mode.

At step 420, secondary content management system(s) 132 may initiate pre-fetching and/or pre-buffering of the secondary content item during an idle period preceding the detected user return event. This pre-buffering stage may enable the secondary content item to be ready for immediate playback, reducing or eliminating any playback delay that could negatively impact the user experience. By pre-loading the content during idle times, secondary content management system(s) 132 may optimize performance, ensuring the secondary content item can begin seamlessly once triggered. In some instances, secondary content management system(s) 132 may dynamically adjust the pre-buffering process based on the network conditions and/or anticipated interaction timing.

Following the example above, while the user's smart TV is idle and displaying a screensaver, content pre-fetching and pre-buffering module 308 may retrieve and buffer a secondary content item (e.g., a short promotional video) during the idle interval. This ensures that once detection module 302 identifies the user's re-engagement (e.g., the dismissal of the screensaver), the secondary content item is already locally buffered and can be rendered immediately without perceptible delay. In some instances, secondary content management system(s) 132 may dynamically adjust the pre-buffering and/or pre-fetching processes based on the network conditions and/or anticipated interaction timing. For instance, if network diagnostics from media device 104 indicate reduced bandwidth, content pre-fetching and pre-buffering module 308 may temporarily buffer a lower-resolution version of the secondary content item to guarantee smooth playback upon user return.

At step 430, secondary content management system(s) 132 may activate a transition effect to introduce the secondary content item. As described herein, a transition effect may refer to a visual, auditory, or combined sensory presentation that conveys to the user that the home screen interface is temporarily transitioning to display secondary content while maintaining visual continuity of the home screen environment. The transition effect may include, but is not limited to, partially displacing the home screen interface and/or presenting the secondary content item within a defined region of the display device (e.g., a central display area).

Continuing the example above, based on the user return event data (e.g., detecting the user's return from the screensaver), transition module 304 may initiate a partial screen slide effect in which the home screen interface subtly shifts downward while dimming the background brightness to emphasize the video advertisement being introduced in the central region of the screen. This transition visually communicates to the user that the device has reactivated and that the ad experience is beginning, while preserving visibility of familiar home screen elements to maintain contextual continuity.

Depending on the desired implementation, other transition effects may be used or selected dynamically based on contextual information. For example, transition module 304 may select or configure a dimming feature in which the brightness of the home screen interface is reduced to emphasize the secondary content item to be presented or being presented. The dimming effect, or any other transition effect, may be configured based on one or more contextual factors, such as, but not limited to time of day, user preferences, secondary content item provider preferences or secondary content item configuration parameters or device performance conditions. Other transition effects may include, but are not limited to, a slide effect, a blur effect, a zoom out effect, a fade out, and/or a partial overlay effect.

In some examples, transition module 304 may determine where on display device 106 to position or render the secondary content item based on device data received from detection module 302. The device data may include on-screen data identifying available region(s) of display device 106, such as, areas not occupied by navigation bars, channel icons, or interface overlays. Based on such determination, transition module 304 may dynamically adjust placement of the secondary content item to a central or otherwise available display region while preserving visibility of key contextual elements surrounding the playback area. For example, upon receiving from detection module 302 an indication that a user has powered on their smart TV for the first time that day, transition module 304 may initiate a partial-screen transition in which the home screen interface slides downward to reveal the secondary content item within a defined central region.

In some aspects, transition module 304 may determine the complexity or intensity of a transition effect based on real-time device performance parameters. For example, on media device(s) 104 and/or display device(s) 106 with limited processing capability, transition module 304 may automatically select a simplified effect, such as a fade-out or slide effect, to ensure smooth rendering and responsiveness. Conversely, on devices with greater rendering capabilities, transition module 304 may employ more elaborate visual transitions, such as blur-based or zoom-based animations, to enhance the presentation quality. The contextual information used to guide this selection may include operational telemetry obtained from media system 102, such as processor load, available memory, rendering frame rate, or network diagnostics. By dynamically determining and applying an appropriate transition effect, transition module 304 ensures that the visual presentation of the secondary content is optimized for both performance efficiency and user experience continuity across device configurations.

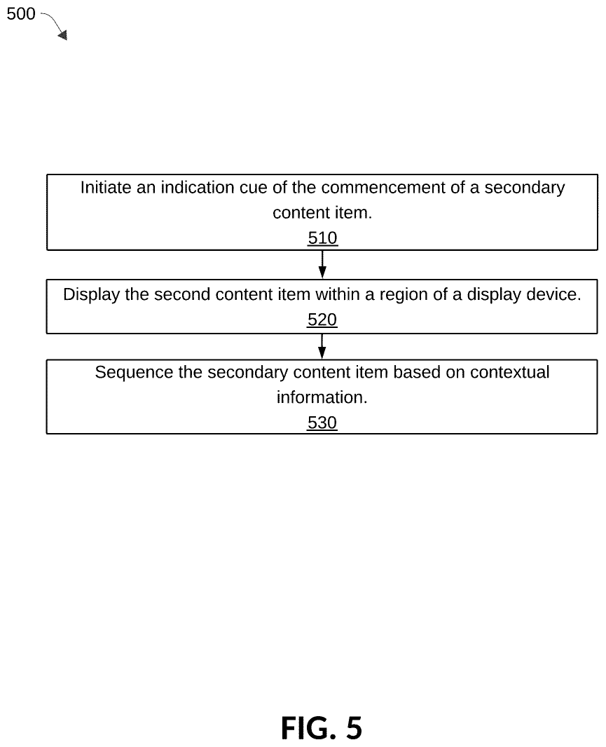

FIG. 5 is a flowchart for a method 500 for presenting a second content item, which can be configured for display based on a pre-defined criteria, such as a time of day or prior user interactions, according to some aspects of the disclosed technology. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-3. However, method 500 is not limited to that example. In step 510, secondary content management system(s) 132 may initiate an indication cue of the commencement of a secondary content item. As described herein, an indication cue may serve as a sensory pre-signal that communicates the start or impending start of the display, presentation or play back of a secondary content item. Moreover, the indication cue may include, but is not limited to an audio and/or visual cue. For example, an audio cue could consist of a short chime or sound that signals the beginning of the ad experience. In another example, a visual cue such as an ad slate displaying a contextually relevant message or brand identifier can be used to prepare the user for the ad experience.

For example, after detection module 302 identifies that the user has returned from a screensaver following an idle period, indication module 306 may initiate an audio cue, such as a playback of a short and pleasant chime and/or display a visual cue, such as a branded ad slate that fades into view along the top portion of display device 106 (e.g., an ad slate that includes a subtle “Presented By” logo associated with the secondary content provider) to signal to the user that media device 104 and/or display device 106 is resuming active use and/or that a second content item (e.g., an advertisement) is about to begin. This indication cue sequence, initiated immediately after a transition effect, may be timed to occur within a predetermined period (e.g., one to two seconds) after the home screen reappears. The indication cue sequence may provide a natural lead-in to the second content item while preserving the continuity of the user experience.

In step 520, secondary content management system(s) 132 may display the second content item within a region of a display device. Unlike traditional full-screen advertisements, which can be disorienting to users, the partial-screen placement of the second content item within the region of the display device, such as the central region of the display device, maintains user awareness of the home screen interface. This positioning allows the second content item to be prominently visible while preserving the user's perception of the underlying home screen interface, facilitating a smoother transition back to the home screen interface once the second content item concludes. In some instances, the second content item playback area can be designed to dynamically resize or adapt based on screen dimensions to ensure an optimal viewing experience across various types and/or configurations of media device(s) 104 and/or display device(s) 106.

Continuing from the example above, once the indication cue sequence has concluded, transition module 304 may render the secondary content item, a 15-second promotional video, within the central region of the screen while dimming the surrounding home screen interface. In some instances, the secondary content item may be pre-buffed and/or pre-fetched. The placement ensures that key navigation icons and interface elements of the home screen interface remain faintly visible in the background, while reinforcing to the user that the advertisement is a temporary layer over the home screen. Upon completion of the presentation of the secondary content item, the home screen interface brightness may gradually return to its prior level, signaling that the device has resumed its default state.

In step 530, secondary content management system(s) 132 may sequence the secondary content item based on contextual information. As described herein, the contextual information may include predefined times of day and/or prior user interactions. In some aspects, sequencing logic can be used to enhance secondary content item relevancy and maximize engagement by tailoring the delivery of secondary content item to specific times, such as prime viewing hours, or by adapting based on historical user behavior. For instance, a user that frequently interacts with the device during evening hours may be targeted with a secondary content item scheduled specifically for that time period. Alternatively, users who have interacted with similar content or have previously engaged with specific types of advertisements may be served with a tailored secondary content item that align with their interests and habits. This time-based and behavior-based sequencing helps optimize secondary content item performance while delivering a personalized experience that is less likely to be perceived as intrusive.

Following the example above, sequencing module 310 may determine, based on user interaction history and engagement analytics stored in system server(s) 126, that the user typically interacts with entertainment-related advertisements during evening hours. Accordingly, sequencing module 310 may prioritize presentation of the secondary content item for a newly released primary content item (e.g., a TV series) immediately following the screensaver dismissal event. During the user's next re-engagement later in the same evening, sequencing module 310 may select and deliver a second secondary content item (e.g., short-form ad related to the same campaign as the previously presented secondary content item).

The sequence of operations illustrated in method 500 further refines the secondary content item delivery method, ensuring that ads are shown at appropriate times, in a user-friendly format, and with sensory cues that respect the user's primary interaction with the home screen interface. Additional variations and configurations may include custom scheduling rules, frequency caps, and contextual adjustments, as described in further embodiments. This approach provides advertisers with a robust tool to achieve high engagement rates while enhancing the user experience on the media device 104 and/or display device 106.

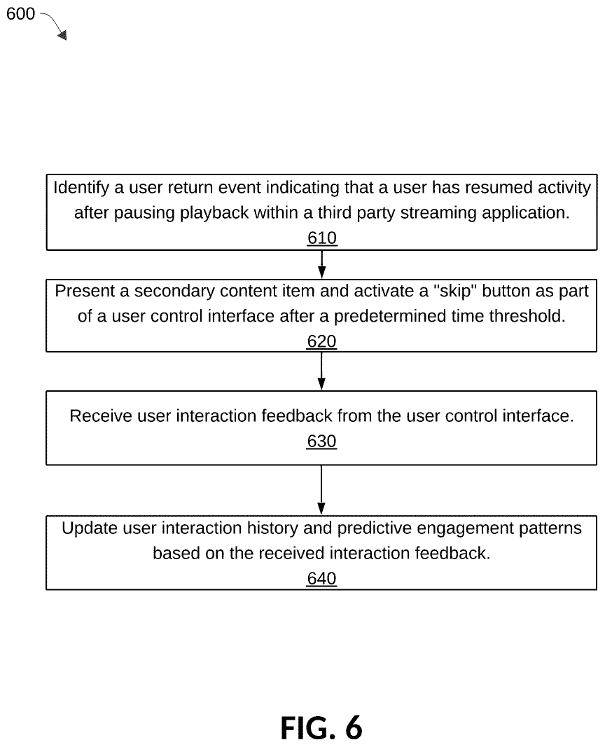

FIG. 6 is a flowchart for a method 600 for processing user interaction feedback associated with a secondary content item, according to some aspects of the disclosed technology. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 1-3. However, method 600 is not limited to that example. In step 610, secondary content management system(s) 132 may identify a user return event indicating that the user has resumed activity after pausing playback within a third-party streaming application. For example, detection module 302 may detect that the user exited a paused streaming session and navigated back to the home screen interface. Based on this event, detection module 302 may generate user return event data including a timestamp and device state indicator, and may provide the data to transition module 304, indication module 306, and user control interface module 309.

At step 620, secondary content management system(s) 132 may present a secondary content item and activate a “Skip” button as part of the user control interface after a predetermined time threshold. As described herein, user control interface module 309 may render the “Skip” button in a lower-right region of the home screen interface once the secondary content item has played for a minimum interval (e.g., five seconds). The activation timing may be determined based on configuration parameters retrieved from system server(s) 126 or secondary-content-provider metadata. For example, once five seconds of a 20-second promotional video have elapsed, user control interface module 309 may visually fade in the “Skip” button to provide the user with the option to dismiss the content early.

At step 630, secondary content management system(s) 132 may receive user interaction feedback from the user control interface. When the user selects the “Skip” button, user control interface module 309 may transmit an interaction signal to transition module 304 indicating that playback should terminate. Transition module 304 may then initiate a fade-out transition effect to smoothly remove the secondary content item and restore full visibility of the underlying home screen interface. Further, sequencing module 310 may record the skip event as part of engagement metric(s) or parameter(s) associated with the user.

At step 640, sequencing module 310 may update user interaction history and predictive engagement patterns based on the received interaction feedback. For instance, sequencing module 310 may determine that the user tends to skip promotional content shorter than 20 seconds when returning from a paused streaming application. Using this determination, sequencing module 310 may update frequency caps or prioritization rules stored in system server(s) 126 to reduce the likelihood of presenting similar short-form ads during subsequent return events of the same type. During future re-engagements, secondary content management system(s) 132 may reference the updated parameters to dynamically adjust sequencing or presentation logic, ensuring that subsequent secondary content items align more closely with the user's demonstrated engagement behavior while maintaining continuity of the home screen experience.

### Example Computer System

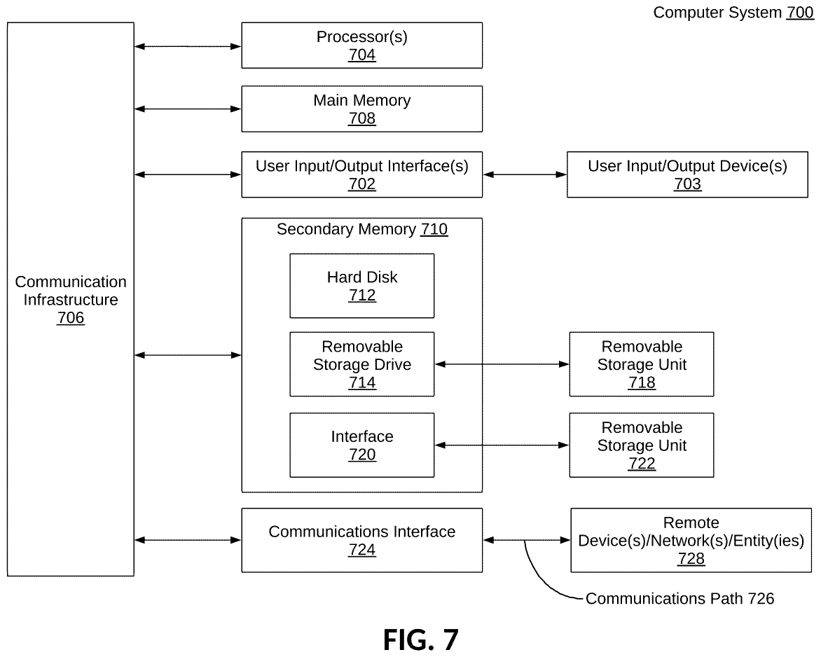

Various embodiments may be implemented, for example, using one or more well-known computer systems, such as computer system 700 shown in FIG. 7. For example, the media device 104 may be implemented using combinations or sub-combinations of computer system 700. Also, or alternatively, one or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706. Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700 or processor(s) 704), may cause such data processing devices to operate as described herein.

The computer system 700, or instructions executed thereon, can be implemented to perform all, or a part of any of the following aspects:

Aspect 1. A method for delivering an interactive video advertisement comprising: detecting a user return event; pre-fetching and pre-buffering video ad content during an idle period preceding the user return event to minimize playback delay; initiating a transition effect upon the user return event that partially displaces a home screen interface and displays a video ad in a central region of a screen; indicating commencement of a video ad experience; providing user controls on the home screen; and enabling sequencing of the video ad content based on predefined times of day or prior user interactions, wherein the method optimizes video reach while maintaining an integrated and minimally disruptive user experience on the home screen.

Aspect 2. The method of Aspect 1, wherein the user return event is one of: a device boot, a screensaver dismissal, an entrance or exit from a first-party or third-party channel, or a return to the home screen after device idle time.

Aspect 3. The method of any of Aspects 1 to 2, wherein initiating a transition effect upon the user return comprises introducing an audio cue or visual cue, wherein the audio cue comprises a short chime, and the visual cue includes an ad slate providing contextually relevant information to the user.

Aspect 4. The method of any of Aspects 1 to 3, wherein the video ad displayed in the central region of the screen is played in a partial-screen format configured to preserve a context associated with the home screen for the user.

Aspect 5. The method of any of Aspects 1 to 4, wherein the user controls on the home screen include options to skip the video ad after a predefined time threshold, close the video ad, opt-out of video autoplay in system settings, and interact with leave-behind companion units.

Aspect 6. The method of any of Aspects 1 to 5, wherein the user return event further includes entering or exiting a custom sponsorship experience displayed on the home screen, such as a destination page or microsite.

Aspect 7. The method of any of Aspects 1 to 6, wherein the video ad experience further includes a configurable skip button that is activated after a defined threshold duration within the video ad, allowing the user to bypass a remainder of the ad.

Aspect 8. The method of any of Aspects 1 to 7, wherein the pre-buffering of video ad content dynamically adjusts based on network conditions and anticipated user interaction timing, minimizing latency when the video ad is triggered.

Aspect 9. The method of any of Aspects 1 to 8, further comprising a secondary ad slate or overlay that displays contextually relevant messages or visuals around a playback area of the video ad experience, wherein the ad slate is dynamically configurable to enhance advertiser messaging based on user engagement metrics.

Aspect 10. The method of any of Aspects 1 to 9, wherein the video ad sequencing allows the display of specific ad content during predefined prime-time blocks or in response to previously detected user behavior patterns, thereby tailoring ad delivery to increase engagement and relevancy.

Aspect 11. A system for delivering an interactive video advertisement on a smart TV home screen, comprising: a detection module configured to detect a user return event; a content pre-fetching and buffering module configured to retrieve and buffer video ad content during an idle period preceding the user return event to minimize playback delay; a transition module configured to initiate a transition effect upon detection of the user return event, wherein the transition effect partially displaces a home screen interface and displays a video ad in a central region of a screen; an indication module configured to signal the commencement of a video ad experience; a user control interface configured to present user controls on the home screen; and a sequencing module configured to enable sequencing of the video ad content based on predefined times of day or prior user interactions, wherein the system optimizes video reach while maintaining an integrated and minimally disruptive user experience on the home screen.

Aspect 12. The system of Aspect 11, wherein the detection module is further configured to identify the user return event as one of: a device boot, a screensaver dismissal, an entrance or exit from a first-party or third-party channel, or a return to the home screen after device idle time.

Aspect 13. The system of any of Aspects 11 to 12, wherein the transition module is further configured to introduce an audio cue or visual cue upon initiating the transition effect, wherein the audio cue comprises a short chime, and the visual cue includes an ad slate providing contextually relevant information to the user.

Aspect 14. The system of any of Aspects 11 to 13, wherein the video ad displayed in the central region of the screen is rendered in a partial-screen format configured to preserve a context associated with the home screen for the user.

Aspect 15. The system of any of Aspects 11 to 14, wherein the user control interface includes options allowing the user to skip the video ad after a predefined time threshold, close the video ad, opt-out of video autoplay in system settings, and interact with leave-behind companion units.

Aspect 16. The system of any of Aspects 11 to 15, wherein the detection module is further configured to recognize a user return event when the user enters or exits a custom sponsorship experience displayed on the home screen, such as a destination page or microsite.

Aspect 17. The system of any of Aspects 11 to 16, wherein the user control interface further includes a configurable skip button that is activated after a defined threshold duration within the video ad, allowing the user to bypass the remainder of the ad.

Aspect 18. The system of any of Aspects 11 to 17, wherein the content pre-fetching and buffering module dynamically adjusts pre-buffering of video ad content based on network conditions and anticipated user interaction timing, minimizing latency when the video ad is triggered.

Aspect 19. The system of any of Aspects 11 to 18, further comprising a secondary ad slate or overlay module configured to display contextually relevant messages or visuals around a playback area of the video ad experience, wherein the ad slate is dynamically configurable to enhance advertiser messaging based on user engagement metrics.

Aspect 20. A non-transitory computer-readable storage medium comprising at least one instruction for causing a computer or processor to: detect a user return event; pre-fetch and pre-buffering video ad content during an idle period preceding the user return event to minimize playback delay; initiate a transition effect upon the user return event that partially displaces a home screen interface and displays a video ad in a central region of a screen; indicate commencement of a video ad experience; provide user controls on the home screen; and enable sequencing of the video ad content based on predefined times of day or prior user interactions, wherein the method optimizes video reach while maintaining an integrated and minimally disruptive user experience on the home screen.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method for delivering a secondary content item comprising:
detecting a user return event;
pre-fetching and pre-buffering a secondary content item during an idle period preceding the user return event; and
initiating a transition effect based on the user return event, the transition effect includes partially displacing a home screen interface and displaying the secondary content item in a defined region of a screen.

2. The computer-implemented method of claim 1, wherein the user return event is at least one of a device boot, a screensaver dismissal, an entrance from a first-party channel, an exit from the first-party channel, an entrance from a third-party channel, an exit from the third-party channel and a return to the home screen interface after device idle time.

3. The computer-implemented method of claim 1, wherein initiating the transition effect upon the user return event comprises providing one or more indication cues.

4. The computer-implemented method of claim 1, wherein the secondary content item displayed in the defined region of the screen is played in a partial-screen format that is configured to preserve a context associated with the home screen interface for a user.

5. The computer-implemented method of claim 1, further comprising:
providing user controls on the home screen interface, wherein the user controls include at least one of a first interaction feature associated with skipping the secondary content item after a predefined time threshold, a second interaction feature associated with closing the secondary content item, a third interaction feature associated with opting-out of autoplay of the secondary content item in system settings, and a fourth interaction feature associated with interacting with one or more leave-behind companion units.

6. The computer-implemented method of claim 1, wherein the user return event further includes entering or exiting a custom sponsorship experience displayed on the home screen interface.

7. The computer-implemented method of claim 1, wherein the pre-buffering of the secondary content item comprises dynamically adjusting one or more parameters of the secondary content item based at least one of one or more network conditions and anticipated user interaction timing.

8. A system for delivering a secondary content item, the system comprising:
at least one memory; and
at least one processor coupled to the at least one memory, the at least one processor is configured to perform operations comprising:
detecting a user return event;
pre-fetching and pre-buffering a secondary content item during an idle period preceding the user return event; and
initiating a transition effect based on the user return event, the transition effect includes partially displacing a home screen interface and displaying the secondary content item in a defined region of a screen.

9. The system of claim 8, wherein the user return event is at least one of a device boot, a screensaver dismissal, an entrance from a first-party channel, an exit from the first-party channel, an entrance from a third-party channel, an exit from the third-party channel and a return to the home screen interface after device idle time.

10. The system of claim 8, wherein initiating the transition effect upon the user return event comprises providing one or more indication cues.

11. The system of claim 8, wherein the secondary content item displayed in the defined region of the screen is played in a partial-screen format that is configured to preserve a context associated with the home screen interface for a user.

12. The system of claim 8, wherein the at least one processor is configured to perform operations further comprising:
providing user controls on the home screen interface, wherein the user controls include at least one of a first interaction feature associated with skipping the secondary content item after a predefined time threshold, a second interaction feature associated with closing the secondary content item, a third interaction feature associated with opting-out of autoplay of the secondary content item in system settings, and a fourth interaction feature associated with interacting with one or more leave-behind companion units.

13. The system of claim 8, wherein the user return event further includes entering or exiting a custom sponsorship experience displayed on the home screen interface.

14. The system of claim 8, wherein pre-buffering the secondary content item comprises dynamically adjusting one or more parameters of the secondary content item based at least one of one or more network conditions and anticipated user interaction timing.

15. A non-transitory computer-readable storage medium comprising at least one instruction for causing at least one computing device to perform operations comprising:
detecting a user return event;
pre-fetching and pre-buffering a secondary content item during an idle period preceding the user return event; and
initiating a transition effect based on the user return event that partially displaces a home screen interface and displays the secondary content item in a defined region of a screen.

16. The non-transitory computer-readable storage medium of claim 15, wherein the user return event is at least one of a device boot, a screensaver dismissal, an entrance from a first-party channel, an exit from the first-party channel, an entrance from a third-party channel, an exit from the third-party channel and a return to the home screen interface after device idle time.

17. The non-transitory computer-readable storage medium of claim 15, wherein initiating the transition effect upon the user return event comprises providing one or more indication cues.

18. The non-transitory computer-readable storage medium of claim 15, wherein the secondary content item displayed in the defined region of the screen is played in a partial-screen format that is configured to preserve a context associated with the home screen interface for a user.

19. The non-transitory computer-readable storage medium of claim 15, wherein the at least one computing device further performs operations comprising:
providing user controls on the home screen interface, wherein the user controls include at least one of a first interaction feature associated with skipping the secondary content item after a predefined time threshold, a second interaction feature associated with closing the secondary content item, a third interaction feature associated with opting-out of autoplay of the secondary content item in system settings, and a fourth interaction feature associated with interacting with one or more leave-behind companion units.

20. The non-transitory computer-readable storage medium of claim 15, wherein the user return event further includes entering or exiting a custom sponsorship experience displayed on the home screen interface.
